(19) United States
(12) Patent Application Publication
(10) Pub. No.: US 2019/0072155 A1
(43) Pub. Date: Mar. 7, 2019

(54) PENDULUM-BASED RESONATING ENERGY SYSTEM

(71) Applicant: Jeremy Arthur GUTTMAN, Tel Aviv (IL)

(72) Inventor: Jeremy Arthur GUTTMAN, Tel Aviv (IL)

(21) Appl. No.: 16/006,864

(22) Filed: Jun. 13, 2018

Related U.S. Application Data
(60) Provisional application No. 62/554,106, filed on Sep. 5, 2017.

(51) Int. Cl. F16F 15/315; F16D 21/00; F16D 48/06

(52) U.S. Cl. CPC F16F 15/315; F16D 2500/104; F16D 48/06; F16D 21/00

(57) ABSTRACT

A system for driving a mechanical load, comprising: a rotational motor; a pendulum affixed to a pendulum axis to allow oscillation and rotation of the pendulum about the pendulum axis; a rotary encoder configured to generate an encoder signal responsively to an angular position of the pendulum with respect to the pendulum axis; a controller configured to receive the encoder signal and responsively to generate first and second controller signals, wherein the first controller signals are indicative of an angular speed of the pendulum being within a predefined motor engage range, and wherein the second controller signals are indicative of the angular speed of the pendulum being above a predefined load engage speed; a first clutch configured to receive the first controller signals and responsively to engage the motor and the pendulum axis; and a second clutch configured to receive the second controller signals and responsively to engage the pendulum axis and the mechanical load, wherein the mechanical load is a linear or rotational machine.

### FIELD OF THE INVENTION

The present invention is directed to systems and methods for energy storage and transmission.

### BACKGROUND

Many machines require a high level of drive torque when they begin operating, but subsequently operate efficiently on a lower level of drive torque. Motors that may be available for a given application may not be able to provide the initial level of torque directly. In addition, systems for converting the low torque of a typical motor to a high torque are generally complex and expensive. Also, the available source of energy in a remote location, such as wind, water, or solar energy, may limit the size of a motor that can operate efficiently.

### SUMMARY

In embodiments of the present invention, a system transmits rotational kinetic energy to a pendulum and releases that energy when there is sufficient torque to power a load such as an external, target machine. A system typically includes: a rotational motor; a pendulum affixed to a pendulum axis to allow oscillation and rotation of the pendulum about the pendulum axis; a rotary encoder configured to generate an encoder signal responsively to an angular position of the pendulum with respect to the pendulum axis; a controller configured to receive the encoder signal and responsively to generate first and second controller signals, wherein the first controller signals are indicative of an angular speed of the pendulum being within a predefined motor engage range, and wherein the second controller signals are indicative of the angular speed of the pendulum being above a predefined load engage speed; a first clutch configured to receive the first controller signals and responsively to engage the motor and the pendulum axis; and a second clutch configured to receive the second controller signals and responsively to engage the pendulum axis and the mechanical load. The mechanical load is typically a linear or rotational machine.

In some embodiments, the controller is further configured to generate the first controller signals when the pendulum is rotating. The controller may be a programmable microcontroller, and configuration of the controller may include loading a memory of the controller with programmable instructions to be executed by a processor of the controller. Typically, the mechanical load is one of a pump, a compressor, a drive shaft, a conveyor belt, or a generator. The system may also include a potentiometer configured to receive input electrical power and to supply adjustable power to the motor, wherein the motor is further configured to operate at a frequency determined by the adjustable power.

The electrical power may be direct current (DC) power. The potentiometer may also be configured to receive a user input to determine a speed of the motor. Typically, the pendulum includes a bob, mounted at the distal end of the pendulum, wherein the bob weight and pendulum length are sized according to a required starting torque of the mechanical load. One or more structural supports generally support the pendulum axis at a height permitting unobstructed oscillation of the pendulum. In addition, at least one shock absorber may be affixed to the one or more structural supports to dampen mechanical vibrations of the structural support during oscillation and rotation of the pendulum.

The present invention will be more fully understood from the following detailed description of embodiments thereof.

### BRIEF DESCRIPTION OF DRAWINGS

Objects and advantages of the present invention will become more apparent and more readily appreciated from the following description of the preferred embodiments, taken in conjunction with the accompanying drawings, of which:

FIG. 1 is a schematic, pictorial illustration of a side-view of a pendulum-based resonant energy storage system, according to an embodiment of the present invention;

FIG. 2 is a schematic, pictorial illustration of a front-view of the pendulum-based resonant energy storage system, according to an embodiment of the present invention;

FIG. 3 is a schematic, pictorial illustration of an electrical circuit of the pendulum-based resonant energy storage system, according to an embodiment of the present invention;

FIG. 4 is a flow diagram of a process for exploiting the energy storage of the pendulum-based resonant energy storage system, according to an embodiment of the present invention; and

FIGS. 5A-5D are schematic, pictorial illustrations of the pendulum-based resonant energy storage system during operation, according to an embodiment of the present invention.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

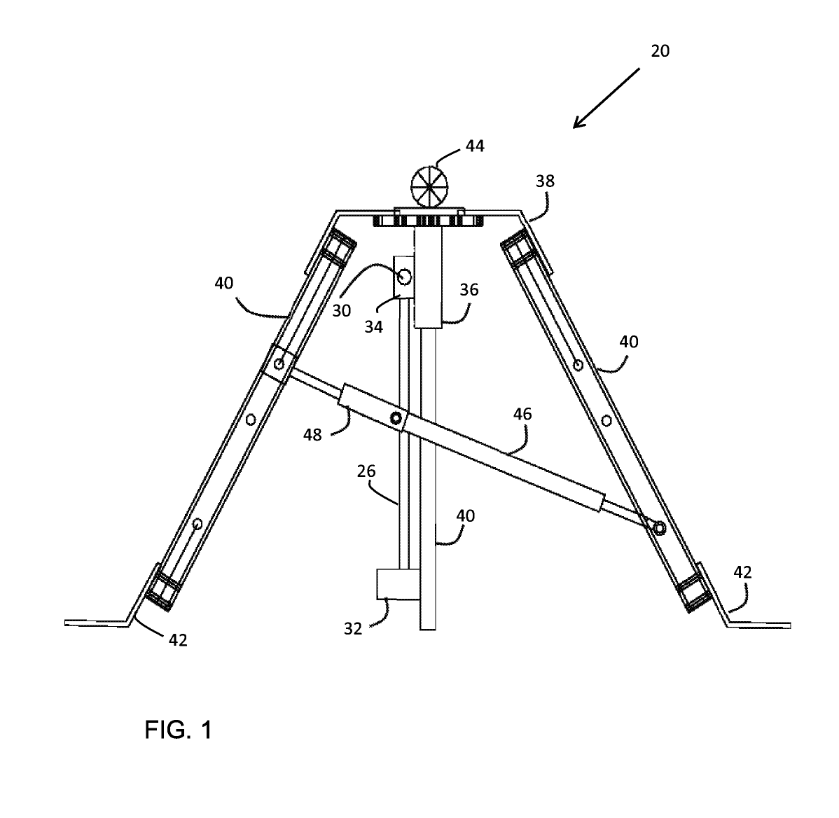

FIG. 1 is a schematic, pictorial illustration of a side-view of a pendulum-based resonant energy storage system 20, according to an embodiment of the present invention. A pendulum 30 is mounted to a pendulum axis 32, about which the pendulum pivots. At the distal end of the pendulum is a bob, or weight 34.

The pendulum axis is typically mounted to a block bearing 34, such as a pillow block bearing, which is in turn attached to a bearing attachment block 36. The block is attached to a frame bracket 38, which is in turn attached to multiple legs, or support columns 40. The frame bracket 38 and the support columns 40 together constitute the basic frame of the system, which is configured to ensure that the pendulum axis is positioned sufficiently high above the ground to allow the pendulum to oscillate freely. The support columns are typically mounted to the ground by ground attachment brackets 42.

A drive motor 44, typically a direct current (DC) motor, is mounted to the frame of the system, typically being mounted to the frame bracket. The motor may be either reversible or non-reversible, and may be either a permanent magnet or wound field motor. As described further hereinbelow, the motor is configured to provide resonant kinetic energy to the pendulum while the pendulum oscillates and to continue providing energy while the pendulum rotates about its pivot.

Typically one or more shock absorbers 46 are connected between support columns to reduce lateral oscillation of the support columns while the pendulum is oscillating and rotating. Each shock absorber also includes a tensioner 48, which allows the tension to the shock absorbers to be tuned, typically by means of a turnbuckle that can be rotated clockwise or counter clockwise.

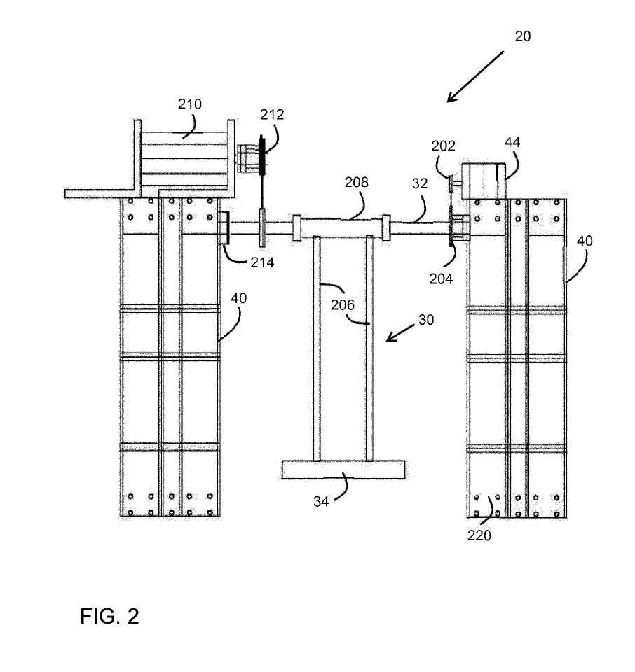

FIG. 2 is a schematic, pictorial illustration of a front-view of the pendulum-based resonant energy storage system 20, according to an embodiment of the present invention. The front-view illustration includes several elements of the system also shown in FIG. 1, these being the pendulum 30, the pendulum axis 32, the pendulum bob or weight 34, several of the support columns 40, and the motor 44. Additional system elements seen in the front-view include a drive motor shaft 202, which is typically connected, directly or by a belt, chain or gear, to a drive clutch 204. The drive clutch may be releasably engaged to the pendulum axis. The pendulum itself typically includes multiple rods 206 to support the weight, these rods typically being clamped to the axis by one or more brackets 208 or by similar connection means.

The drive motor is generally positioned above a support column towards one end of the pendulum axis. Typically positioned towards the other end is a mechanical load, that is, a machine 210 (also referred to hereinbelow as an “external machine”) configured to consume power from the rotational energy of the pendulum axis. In various embodiments, the machine may be either a linear or rotational machine. In a linear machine configuration, the machine may include leadscrews, ball screws, or belts that transform rotational power to move ball, slide, or wheel guides. Types of applications for the machine include operation as a pump, a compressor, a drive shaft, a conveyor belt, or a generator, as well as any other type of operation requiring linear or rotational power. The length of the pendulum and the weight of the pendulum bob are factors that may be adjusted according to the start-up torque required by the machine.

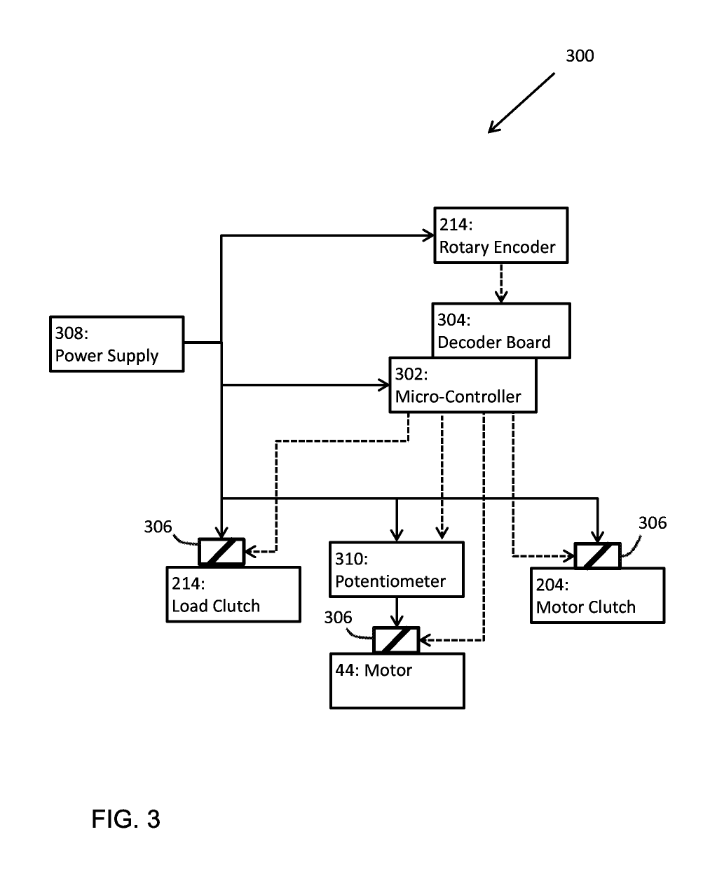

The machine is typically releasably engaged to the pendulum axis through a machine clutch, or load clutch 212. Operation of the drive clutch and machine clutch is described further hereinbelow with respect to FIG. 3.

System 20 also includes a rotary encoder 214, which generates a signal indicative of an angular position of the axis, and which also may be configured to provide the microcontroller with a speed indication signal, which alternatively may be calculated by the microcontroller. Incremental encoders that provide speed, direction and relative position feedback are available, for example from Dynapar™. An exemplary encoder may provide binary pulses proportional to the rotation of a motor or driven shaft. The encoder may be either optical or magnetic, and may be incorporated as shafted with coupling, hollow-shaft, hub-shaft or bearingless. The encoder may be a single, dual, or quadrature channel encoder.

System support columns typically include attachment points 220, by which the columns are attached to the ground attachment brackets described above with respect to FIG. 1. System 20 also includes additional electrical elements described further hereinbelow with respect to FIG. 3. Generally, during field operation, system 20 also includes a protective cover, not shown in the illustration. The cover is large enough to permit full rotation of the pendulum under the cover, thereby shielding users who may be in the vicinity of the system. The cover generally includes a hatch or opening permitting user access to the system components.

FIG. 3 is a schematic, pictorial illustration of an electrical circuit 300 of the pendulum-based resonant energy storage system 20, according to an embodiment of the present invention. The rotary encoder 214, described above with respect to FIG. 2, provides a position signal indicating the angular position of the pendulum axis. The signal is typically conveyed by a wired connection to a decoder 304 of a controller 302, typically a microcontroller configured for direct current (DC) signal processing.

The microcontroller is typically an industry standard controller including on a single board one or more of an Advanced RISC Machines (ARM) processor, a Linux™ real-time operating system, a programmable field-programmable gate array (FPGA), a memory, analog and digital I/O ports and connectors. An exemplary microcontroller is the CompactRIO™ Single-Board Controller from National Instruments™.

Wireless means of communications may also be employed in alternative embodiments of the invention. The microcontroller has a memory which stores programmed logic, that is, programmed instructions, which are executed by a processor of the microcontroller to perform the steps described further hereinbelow.

From multiple readings of the rotary encoder signals, the microcontroller determines a speed as well as an angular position of the pendulum axis. According to these parameters, the microcontroller may operate the load clutch 214, the motor clutch 204, and the motor 44. Typically the operation of these devices is controlled by transmitting on/off signals from the microcontroller to relays 306. These relays control the provision of power to the respective devices. Depending on a variety of factors, such as the electrical loads of the respective devices, the appropriate relays may be electromechanical armature relays, reed relays, field-effect transistor (FET) relays, and solid-state relays. In an embodiment of the present invention that includes a reversible motor, the microcontroller controls one or more motor relays to reverse the polarity of the power line to the motor so as to reverse the direction of operation.

A power supply 308 is generally a DC power supply that employs step-down and step-up (buck and boost) converters to provide the appropriate voltage levels required by the different devices of the system. The power supply may a battery, an renewable power source such as a photoelectric or wind energy source, or may be grid connected,

Typically, power to the motor is also moderated by a potentiometer 310, which can be controlled either by the microcontroller, or manually by a user of the system, to ramp up the speed of rotation.

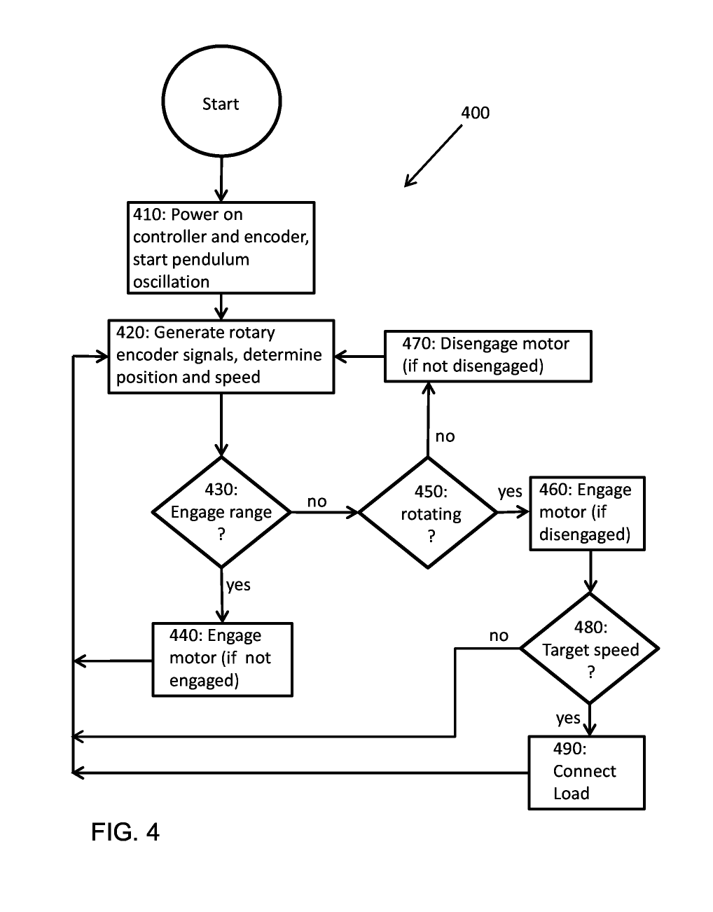

FIG. 4 is a flow diagram of a process 400 performed by the pendulum-based resonant energy storage system 20, according to an embodiment of the present invention. As described below, the system enables a relatively small motor to drive a machine with a high torque start-up requirement. The necessary torque is generated with the assistance of resonance of the pendulum to build up sufficient angular momentum. The process begins at a step 410, with the powering on of the microcontroller and the encoder. Generally, a user manually powers on the system from a mains power grid, though alternatively the system may be powered on by a preset timer device and furthermore may be powered by other energy sources. In addition, in some embodiments, the pendulum may be given an initial angular momentum by a user, that is, the user may manually push the pendulum, in order to start the pendulum oscillation and reduce the start-up torque that the motor must provide. Upon start-up, the microcontroller may also turn on the motor, sending a trigger signal to the motor relay described above. Alternatively the microcontroller may turn on the motor only when motor power is required, as described below, or the motor may be operating continuously on alternative power, for example when powered by solar or wind power.

At a step 420, the rotary encoder generates signals indicative of the angular position of the pendulum, first during the back and forth oscillation of the pendulum and subsequently when the pendulum is rotating about its axis. The microcontroller receives these signals and determines a position and speed of the pendulum.

Based on the position and speed of the pendulum, the microcontroller determines at a step 430 whether the pendulum is oscillating and is currently in a “motor engage range”. Generally this range begins when the pendulum has begun its downswing and ends before the pendulum has reached the top of its upswing, after the pendulum has decelerated to less than a minimum upward angular speed.

If the pendulum is in this range, then the microcontroller transmits a signal to the motor clutch, at a step 440, to engage the motor and the pendulum axis, in order that the motor can impart an additional angular momentum to the axis. (In alternative embodiments, the motor can operate in both forward and backward directions, such that the engage range is in both directions and the microcontroller provides an additional signal directly to the motor to control the direction.) Subsequently to transmitting the engage signal to the motor clutch (or determining that the signal is not necessary because the clutch is already engaged), the microcontroller operation reverts to step 420, so as to receive further encoder signals and to repeat the sequence of steps.

If the pendulum is not in the “engage range” of its oscillation, then, at a step 450, the microcontroller performs a further conditional test, determining if the pendulum is currently rotating. If rotating, then at a step 460, the microcontroller transmits a signal to the motor clutch to engage the pendulum axis, assuming that the clutch is not already engaged, in an operation similar to step 440. Generally, if the pendulum is rotating then the angular momentum is sufficient so that the motor may be engaged continuously.

If the pendulum is not in the “engage range” of oscillation and also not rotating, then the motor would have to provide a high torque if engaged, even working against the momentum of the pendulum. Consequently, to avoid this high torque operation, the microcontroller, at a step 470, transmits a signal to the motor clutch to disengage the motor from the pendulum axis, if the clutch is not already disengaged. Subsequently to transmitting the signal, the microcontroller operation reverts to step 420, so as to receive further encoder signals.

After determining that the pendulum is rotating, and after performing step 460 of transmitting a signal to the motor clutch to engage, the microcontroller also determines at a step 480 whether the pendulum axis has reached an angular speed that would provide sufficient torque to start the load, that is, to start-up the external machine. If yes, then at a step 490 the microcontroller transmits a signal to the load clutch to engage the external machine and the pendulum axis (if the clutch is not already engaged). Subsequently to transmitting the signal, the microcontroller operation reverts to step 420, so as to receive further encoder signals.

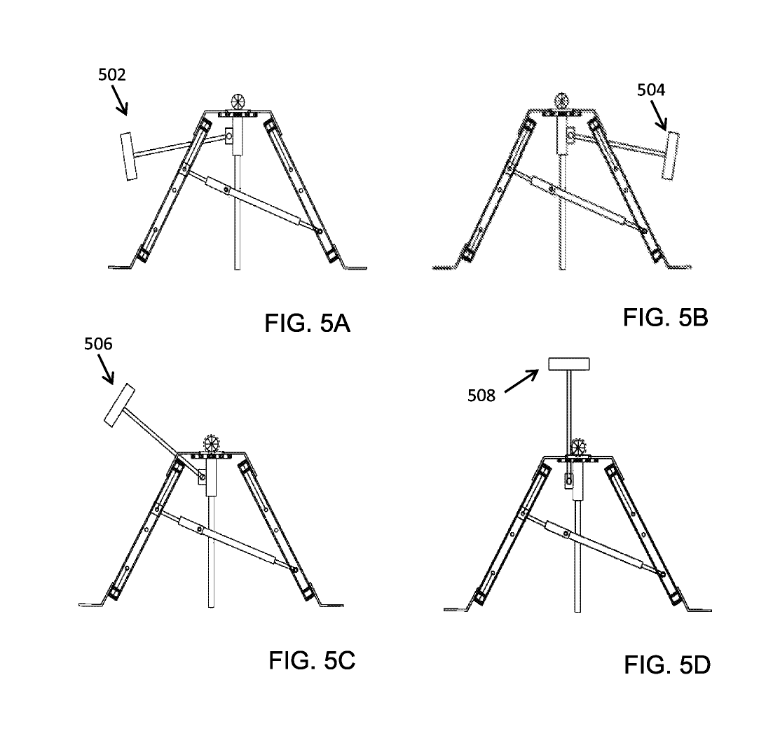

FIGS. 5A-5D are schematic, pictorial illustrations of the pendulum-based resonant energy storage system 20 during operation. FIG. 5A shows the pendulum reaching an apogee of oscillation 502 indicating a moderate amount of potential energy has been imparted to the pendulum. Assuming that position 502 is at the top of a forward motion of the pendulum, then, if the motor is not operated during the backward swing, the pendulum returns during the backward swing to a point 504, as indicated in FIG. 5B, which is approximately the same height as point 502. That is, without receiving a “push” from the motor, the pendulum has the same potential energy at the end of the backward swing, minus the minor frictional/heat losses incurred during the swing. After reaching point 504, the pendulum enters the “engage range” of its swing, and the motor is engaged. Due to the torque applied by the motor, the pendulum at the end of the forward swing has reached a new height 506, as shown in FIG. 5C. Ultimately, after a few more swings, the pendulum will have enough energy to pass the maximum height, indicated as position 508 in FIG. 5D, and to make a full revolution. As described above, the speed of revolution is then monitored by the microcontroller until the speed is sufficient to engage the load. Subsequently, the motor continues to operate, to continue driving the load.

It should be understood that the controller of system 20 and of process 300 can be implemented in digital electronic circuitry, or in computer hardware, firmware, software, or in combinations thereof. Such elements can be implemented as a computer program product, tangibly embodied in an information carrier, such as a machine-readable storage device or in a propagated signal, for execution by data processing apparatus, such as a programmable processor, computer, or multiple computers at the site of the system or at remote sites. Memory storage may also include multiple distributed memory units, including one or more types of storage media. The system may include network interface modules that may control the sending and receiving of data packets over networks.

Method steps associated with the system and process can be rearranged and/or one or more such steps can be omitted to achieve the same, or similar, results to those described herein. It is to be understood that the embodiments described hereinabove are cited by way of example, and that the present invention is not limited to what has been particularly shown and described hereinabove. Rather, the scope of the present invention includes variations and modifications thereof which would occur to persons skilled in the art upon reading the foregoing description and which are not disclosed in the prior art.

1. A system for driving a mechanical load, comprising:
a rotational motor;
a pendulum affixed to a pendulum axis to allow oscillation and rotation of the pendulum about the pendulum axis;
a rotary encoder configured to generate an encoder signal responsively to an angular position of the pendulum with respect to the pendulum axis;
a controller configured to receive the encoder signal and responsively to generate first and second controller signals, wherein the first controller signals are indicative of an angular speed of the pendulum being within a predefined motor engage range, and wherein the second controller signals are indicative of the angular speed of the pendulum being above a predefined load engage speed;
a first clutch configured to receive the first controller signals and responsively to engage the motor and the pendulum axis; and
a second clutch configured to receive the second controller signals and responsively to engage the pendulum axis and the mechanical load, wherein the mechanical load is a linear or rotational machine.

2. The system of claim 1, wherein the controller is further configured to generate the first controller signals when the pendulum is rotating.

3. The system of claim 1, wherein the controller is a programmable microcontroller, and wherein configuration of the controller includes loading a memory of the controller with programmable instructions to be executed by a processor of the controller.

4. The system of claim 1, wherein the mechanical load is one of a pump, a compressor, a drive shaft, a conveyor belt, or a generator.

5. The system of claim 1, further comprising a potentiometer configured to receive input electrical power and to supply adjustable power to the motor, wherein the motor is further configured to operate at a frequency determined by the adjustable power.

6. The system of claim 4, wherein the input electrical power is direct current (DC) power.

7. The system of claim 5, wherein the potentiometer is further configured to receive a user input to determine a speed of the motor.

8. The system of claim 1, wherein the pendulum includes a bob, mounted at the distal end of the pendulum, wherein the bob weight and pendulum length are sized according to a required starting torque of the mechanical load.

9. The system of claim 1, further comprising one or more structural supports that support the pendulum axis at a height permitting unobstructed oscillation of the pendulum.

10. The system of claim 9, further comprising at least one shock absorber affixed to the one or more structural supports to dampen mechanical vibrations of the structural support during oscillation and rotation of the pendulum.
